(19) United States
(12) Patent Application Publication
(10) Pub. No.: US 2009/0086229 A1
(43) Pub. Date: Apr. 2, 2009

(54) Image Processing Device and Pixel Attribute Identification Method

(75) Inventors: Takashi HYUGA, Suwa-shi (JP); Kimitake MIZOBE, Shiojiri-shi (JP); Nobuhiro KARITO, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/243,684

(22) Filed: Oct. 1, 2008

(30) Foreign Application Priority Data
Oct. 2, 2007 (JP) 2007-259051

(51) Int. Cl. H04N 1/60

(52) U.S. Cl. 358/1.9

(57) ABSTRACT

The printer of the invention performs an area classification process to classify each pixel included in an input image read by a scanner as a pixel in an edge component area or a pixel in a halftone dot area, and performs a correction process with a spatial filter suitable for each area. The area classification process calculates a difference value between luminance values of two arbitrary pixels selected among peripheral pixels in a specific pixel range around each target pixel according to each of multiple differential patterns t, compares the calculated difference value with threshold values provided for each differential pattern t to compute multiple difference detection values ht(x) corresponding to the multiple differential patterns t, and gives weights to the computed difference detection values ht(x) to compute a comprehensive difference detection value H(x). The area classification process identifies whether the target pixel is a pixel in the edge component area or a pixel in the halftone dot area, based on the computed comprehensive difference detection value H(x). This arrangement enables high-speed identification of the attribute of each pixel included in an image by such simple operation, while enabling identification of pixel attribute with high accuracy.

### CROSS-REFERENCE TO RELATED APPLICATION

The present application claims the priority from Japanese Patent Application P2007-259051A filed on Oct. 2, 2007, the contents of which are hereby incorporate by reference into this application.

### BACKGROUND

1. Field of the Invention

The present invention relates to a technique of identifying an attribute of each pixel included in an image.

2. Description of the Related Art

Copying machines, image scanners, and facsimiles may perform image correction of image data read by a reading device for output of a higher-quality image. For example, edge enhancement correction is performed for image data representing letters and line works, in order to improve the sharpness of the output image. Color change smoothing correction is performed for image data representing a halftone dot image, in order to reduce the moiré in the output image.

Identification of the attribute of an image as a letter image or a halftone dot image is required for such correction. Especially when an object image to be processed is a mixture of a letter image and a halftone dot image, attribute identification is required for each image area. Some techniques have been proposed for such attribute identification of an image as disclosed in, for example, Japanese Patent Laid-Open No. H04-304776 and No H07-220072.

The technique of the former cited reference computes a tone value distribution or a tone value variation and identifies the attribute of an image based on the matching degree of the computed result with the fuzzy inference. The technique of the latter cited reference performs the linear Fourier transform with regard to each line to compute a spatial frequency characteristic and detects the presence or the absence of a halftone dot structure, its periodicity, and the number of halftone dot lines in an input image based on the classification and the cumulative result of the computed spatial frequency characteristics.

These prior art methods, however, impose the high computation load for calculation of the characteristic value like the tone value distribution or the tone value variation or for the Fourier transform and undesirably lower the processing speed. An expensive hardware configuration is required to solve the problem of the lowered processing speed.

### SUMMARY

With taking into account the problems of the prior art described above, there would be a demand for identifying an attribute of each pixel included in an image by a simple operation.

The present invention accomplishes at least part of the demand mentioned above and the other relevant demands by the following configurations applied to the image processing device.

According to one aspect, the present invention is directed to an image processing device constructed to identify an attribute of each pixel included in an image as a type of an image area. The image processing device has: a data input module configured to read tone value data representing tone values of respective pixels constituting the image; a difference detection value computation module configured to select multiple pixels among a predetermined pixel included in the image and peripheral pixels in a specific range around the predetermined pixel and compute a difference detection value from a difference value between tone values of the selected multiple pixels according to a combination pattern of the selected multiple pixels; and an attribute identification module configured to identify an attribute of the predetermined pixel as the type of an image area, based on the computed difference detection value.

The image processing device according to this aspect of the invention computes the difference detection value from the difference value between the tone values of the multiple pixels selected among the predetermined pixel and the peripheral pixels in the specific range around the predetermined pixels, and identifies the attribute of the predetermined pixel based on the computed difference detection value. This arrangement enables identification of the attribute of each pixel by the simple operation. In the specification hereof the attribute of each pixel is related to the type of the image area which the pixel belongs to, for example, a letter inside area, an edge component area, a halftone dot area, or a photographic image area. The difference detection value includes the difference value itself between the tone values of the multiple selected pixels.

In one preferable application of the image processing device according to this aspect of the invention, the difference detection value computation module provides multiple combination patterns, calculates multiple difference values corresponding to the multiple combination patterns, and computes multiple difference detection values from the calculated multiple difference values.

The image processing device of this arrangement performs comprehensive identification of the attribute of each pixel, based on the multiple difference detection values corresponding to the multiple combination patterns, thus desirably improving the accuracy of attribute identification.

In one preferable embodiment of the image processing device having the above configuration, the attribute identification module gives weights to the multiple combination patterns and uses the weighted multiple combination patterns for identification of the attribute.

The image processing device of this embodiment performs identification of the attribute of each pixel after giving weights to the multiple combination patterns. This arrangement enables attribute identification reflecting the characteristic of each combination pattern, thus improving the accuracy of attribute identification.

In another preferable embodiment of the image processing device having the above configuration, when the computed difference detection value represents a certain result, the difference detection value computation module increases a variety of combination patterns to recompute the difference detection value. The attribute identification module performs identification of the attribute based on the recomputed difference detection value.

In the event of difficulty in accurate attribute identification based on the computed difference detection value, the image processing device of this embodiment increases the variety of combination patterns to recompute the difference detection value and performs attribute identification based on the recomputed difference detection value. This arrangement desirably improves the accuracy of attribute identification. The greater variety of combination patterns is adopted for attribute identification only with regard to the pixels having difficulty in identification according to the less variety of combination patterns. This arrangement ensures the higher-speed attribute identification, compared with unconditional attribute identification with a large variety of combination patterns.

In one preferable embodiment of the invention, the image processing device further has: an information acquisition module configured to obtain image quality-related information on a quality of the image; and a pattern changeover module configured to change over at least a number of combination patters or a variety of combination patterns according to the obtained image quality-related information.

The image processing device of this arrangement changes over at least either the number of combination patterns or the variety of combination patterns according to the image quality-related information, thus enabling the more accurate attribute identification or the higher-speed attribute identification with referring to an optimum combination pattern suitable for the image quality-related information.

The technique of the invention is not restricted to the image processing device having any of the arrangements described above to identify the attribute of a pixel but may also be applied to an image processing device configured to make an image subjected to a series of image processing, as well as a pixel attribute identification method performed by the computer to identify the attribute of a pixel.

### BRIEF DESCRIPTION OF THE DRAWINGS

FIG. 1 schematically illustrates the configuration of a printer in one embodiment of the invention;

FIG. 2 is a flowchart showing an image copy routine executed in the printer of the embodiment;

FIG. 3 is a flowchart showing the details of an area classification process in the image copy routine of FIG. 2;

FIG. 4 is a flowchart showing the details of an attribute identification process in the area classification process of FIG. 3;

FIG. 5 is an explanatory view showing a method of computing a difference value from luminance values;

FIGS. 6A, 6B, and 6C show a concrete example of computation of difference values;

FIG. 7 is a histogram showing polarizations of difference values in an edge component area and a halftone dot area;

FIG. 8 conceptually shows a differential pattern table;

FIG. 9 is a flowchart showing one modified flow of the attribute identification process as a modified example 1; and

FIG. 10 is a flowchart showing another modified flow of the attribute identification process as a modified example 2.

### DESCRIPTION OF THE PREFERRED EMBODIMENTS

### A. Embodiment

One mode of carrying out the invention is described below as a preferred embodiment with reference to the accompanied drawings.

A-1. General Configuration of Printer 10

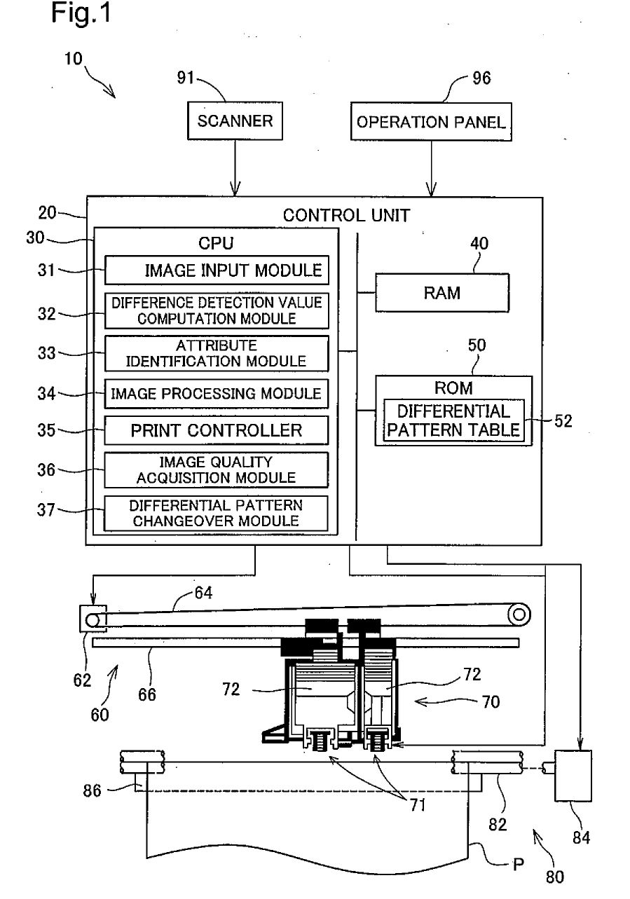

FIG. 1 schematically illustrates the configuration of a printer 10 as one embodiment of the image processing device according to the invention. The printer 10 is a complex machine having scanner functions and copy functions as well as standard printing functions. The printer 10 has a control unit 20, a carriage moving mechanism 60, a carriage 70, a paper feed mechanism 80, a scanner 91, and an operation panel 96.

The carriage moving mechanism 60 has a carriage motor 62, a drive belt 64, and a slide shaft 66 and moves the carriage 70, which is held on the slide shaft 66 in a freely movable manner, in a main scanning direction. The carriage 70 has ink heads 71 and ink cartridge 72 and ejects inks supplied from the ink cartridges 72 to the ink heads 71 onto a sheet of printing paper P. The paper feed mechanism 80 has a paper feed roller 82, a paper feed motor 84, and a platen 86. The paper feed motor 84 rotates the paper feed roller 82 to feed the printing paper P along the top face of the platen 86. The scanner 91 is an image scanner constructed to optically read an image and adopts a CCD (charge coupled device) type in this embodiment, although any of various other types, for example, a CIS (contact image sensor) type, may also be adopted.

These mechanisms of the printer 10 are controlled by the control unit 20. The control unit 20 is constructed as a microcomputer including a CPU 30, a RAM 40, and a ROM 50. A program stored in the ROM 50 is loaded to the RAM 40 and is executed to control the respective mechanisms and work as functional blocks shown in FIG. 1. A differential pattern table 52 is also stored in the ROM 50. The details of the functional blocks and the differential pattern table 52 will be explained later.

The printer 10 having the general configuration discussed above functions as a copying machine by printing an image read by the scanner 91 on the printing paper P. The printing mechanism adopts the inkjet printing method in this embodiment, but may adopt any of various other printing methods, such as a laser printing method or a heat transfer printing method.

A-2. Image Copy Process

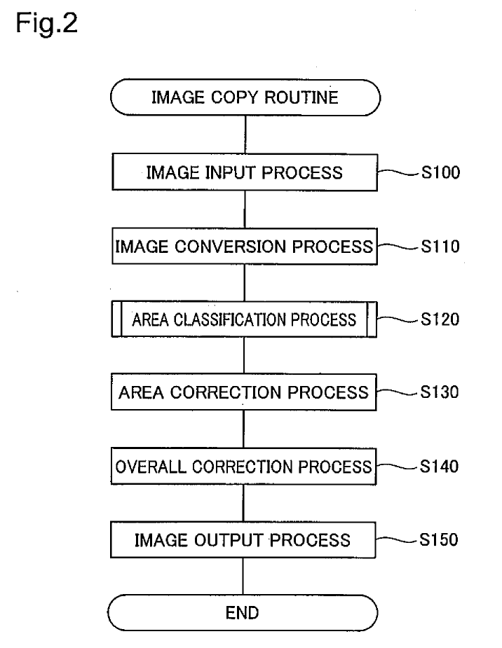

FIG. 2 is a flowchart showing an image copy routine executed to copy a predetermined image in the printer 10. The image copy routine is activated when the user sets an object image as a copy target in the printer 10 and operates the operation panel 96 to give a copy instruction. At the start of the image copy routine, the CPU 30 controls the scanner 91 to convert a focused optical image into an electric signal as an image input process (step S100). As a subsequent image conversion process, the CPU 30 controls an AD conversion circuit to convert the obtained analog signal into a digital signal and performs shading correction to substantially equalize the brightness over the whole image (step S110).

The CPU 30 then performs area classification in the unit of a pixel (step S120). The area classification process classifies pixels included in an image into a pixel group constituting an edge component area and a pixel group constituting a halftone dot area. The details of the area classification will be described later in ‘A-3. Area Classification Process’.

The CPU 30 subsequently controls an image processing module 34 to make correction suitable for each of the classified areas (step S130). A concrete procedure of area correction performs a spatial filtering operation with an enhancement filter for the pixels classified as an edge component area and with a smoothing filter for the pixels classified as a halftone dot area. Such correction enables output of the sharper edge component area and the moiré-controlled halftone dot area in a subsequent image output process at step S150 as explained later.

After the area correction, the CPU 30 performs a required series of operations for overall correction, for example, gamma correction and color correction of reducing a difference in color information between an input image and an output image to enable accurate reproduction of the color in the output image (step S140). The CPU 30 then controls a print controller 35 to drive the carriage moving mechanism 60, the carriage 70, and the paper feed mechanism 80 to print the output image on the printing paper P (step S150). This completes the image copy process.

A-3. Area Classification Process

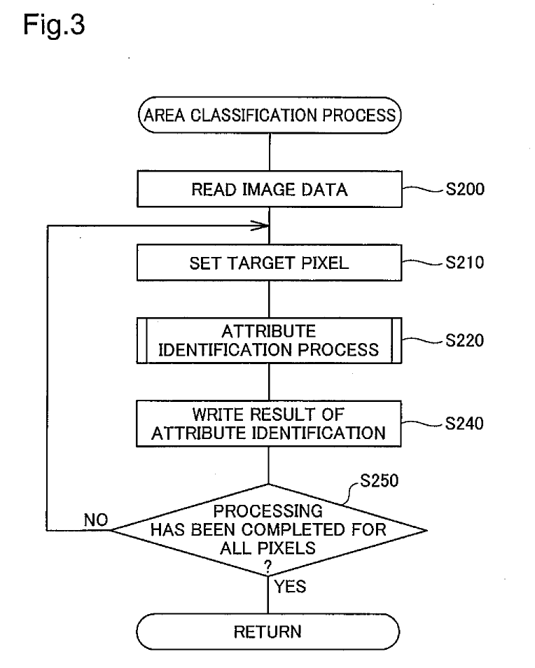

FIG. 3 is a flowchart showing the details of the area classification process executed at step 5120 in the image copy routine of FIG. 2. At the start of the area classification process, the CPU 30 controls an image input module 31 to read image data (RGB data) of an object image obtained at step S110 (in the image copy routine of FIG. 2) into the RAM 40 (step S200) and sets a target pixel (step S210). The target pixel represents an object of attribute identification to identify whether each pixel is classified as a pixel in an edge component area or as a pixel in a halftone dot area. The target pixel is set to a pixel located at an uppermost left end of the image at the start of this area classification process and is successively shifted rightward and downward.

After setting the target pixel, the CPU 30 controls an attribute identification module 33 to perform an attribute identification process to identify whether the target pixel is classified as a pixel in an edge component area or as a pixel in a halftone dot area (step S220). The details of the attribute identification process will be discussed later in ‘A-4. Attribute Identification Process’.

The CPU 30 writes the result of attribute identification of the target pixel into the RAM 40 (step S240) and determines whether the above series of processing has been completed for all the pixels in the object image (step S250). In response to incomplete processing (step S250: no), the processing flow goes back to step S210. In response to complete processing (step S250: yes), on the other hand, the CPU 30 terminates the area classification process and returns the processing flow to the image copy routine of FIG. 2.

A-4. Attribute Identification Process

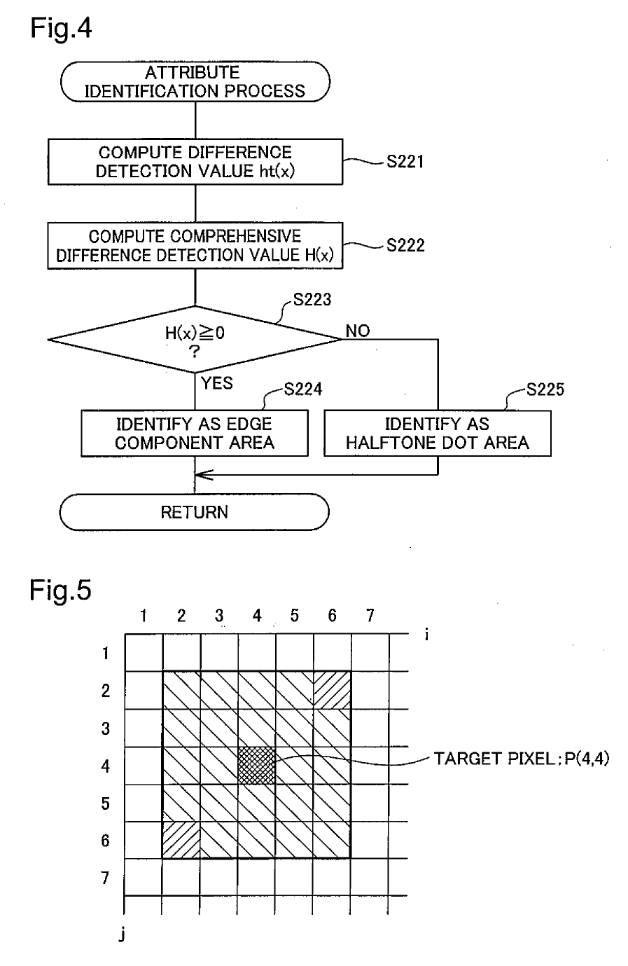

FIG. 4 is a flowchart showing the details of the attribute identification process executed at step S220 in the area classification process of FIG. 3. At the start of the attribute identification process, the CPU 30 controls a difference detection value computation module 32 to compute a difference detection value ht(x) (step S221). The concrete procedure of computing the difference detection value ht(x) is explained below.

The procedure first selects two arbitrary pixels among peripheral pixels in a specific range around a target pixel and calculates a difference value Δf between luminance values of the two selected pixels. The luminance value of each pixel is obtainable from the RGB tone value of the pixel by the known technique. On the assumption that the target pixel is located at an i-th pixel position rightward and a j-th pixel position downward from an uppermost left end of an image and is expressed as P(i,j), the specific range is an area of five pixels in a longitudinal direction and five pixels in a lateral direction around the target pixel P(i,j). The two arbitrary pixels selected among the peripheral pixels in this specific range are, for example, a pixel P(i+2,j−2) and a pixel (i−2,j+2). In the illustrated example of FIG. 5, the target pixel (double-hatched rectangle) is P(4,4) and the two arbitrary pixels (hatched rectangles) are P(6,2) and P(2,6). In the description hereafter such a combination of two arbitrary pixels is referred to as a differential pattern.

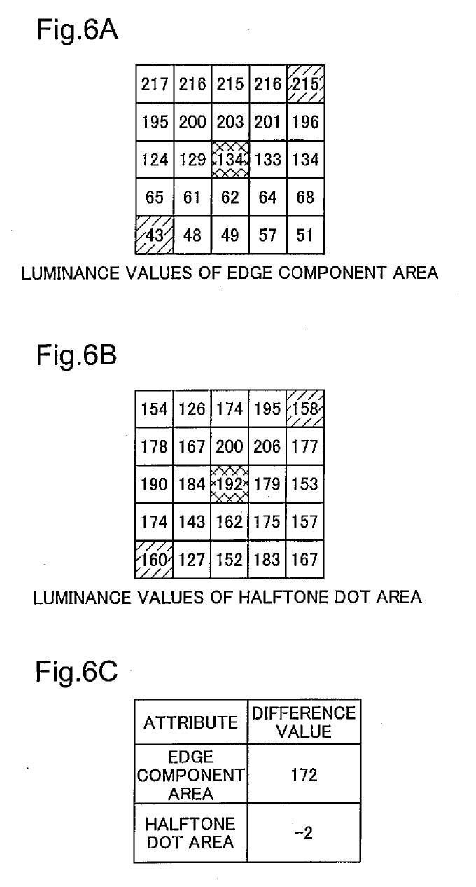

A concrete example of computing the difference value Δf is given in FIGS. 6A through 6C. FIG. 6A shows luminance values of pixels constituting an edge component area of a letter. FIG. 6B shows luminance values of pixels constituting a halftone dot area. The illustrated pixel range corresponds to the area of 5 pixels by 5 pixels mentioned above. FIG. 6C shows computed difference values between the pixel P(6,2) and the pixel P(2,6).

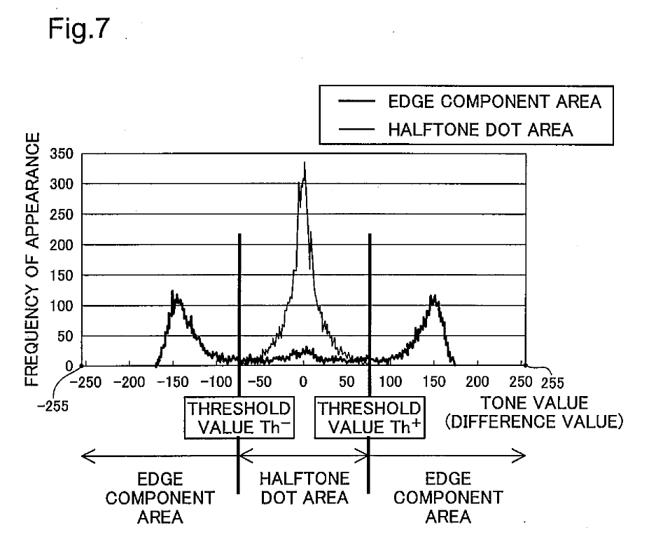

The histogram of FIG. 7 is created by computing the difference value Δf with regard to various areas in various images according to the differential pattern shown in FIG. 5 and FIGS. 6A through 6C. As illustrated, the edge component area and the halftone dot area have different distributions of the difference value Δf. Setting threshold values Th− and Th+ relative to the difference value Δf enables identification of the edge component area or the halftone dot area from the computed difference value Δf with a certain accuracy. The threshold values Th− and Th+ are experimentally or empirically obtained by analyzing a large number of images.

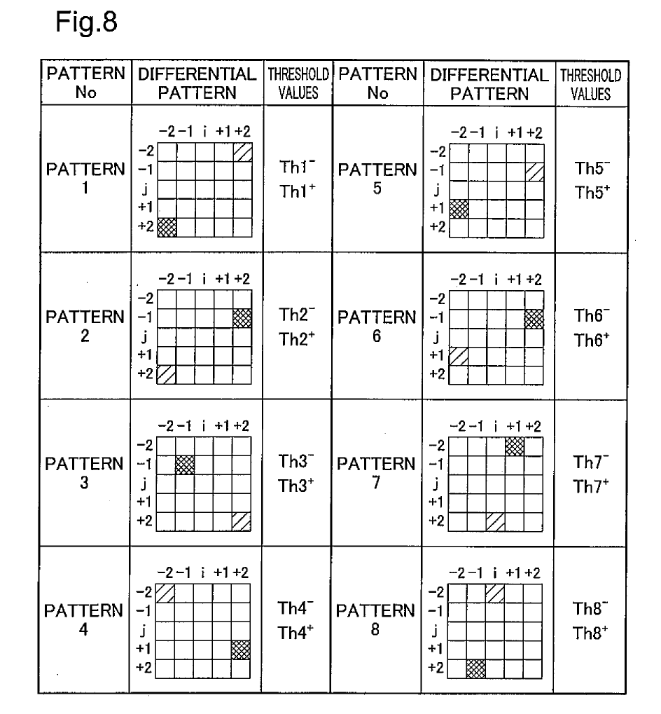

Setting different differential patterns give different threshold values Th− and Th+. A preset number of differential patterns are correlated to corresponding combinations of threshold values Th− and Th+and are stored in the differential pattern table 52 of the ROM 50. FIG. 8 conceptually shows the differential pattern table 52 of the embodiment. Rectangles in FIG. 8 represent pixels in the specific range set for selection of two arbitrary pixels, and a center rectangle represents a target pixel P(i,j). The differential patterns specify not only the combinations of the positions of two selected pixels but the order of the combinations. The combinations of the positions of selected pixels may be set experimentally or empirically. The procedure of this embodiment does not set the differential pattern with selection of the target pixel as one of the two arbitrary pixels. The target pixel may, however, be set to one of the two arbitrary pixels.

The procedure calculates the difference value Δf with regard to each differential pattern ‘t’ (where ‘t’ represents an integer of 1 to 8) stored in the differential pattern table 52 and subsequently computes the difference detection value ht(x) with regard to the differential pattern ‘t’. The difference detection value ht(x) is adopted for attribute identification of the target pixel based on the relation between the difference value Δf and the threshold values Th− and Th+. The difference detection value ht(x) may be defined by Equation (1) given below:

$${h}_{t} ( x ) = \{ \begin{matrix}+ 1 ( Δ f \leq {Th}_{t}^{+} or Δ f \geq {Th}_{t}^{+} \\ - 1 ( {Th}_{t}^{-} < Δ f < {Th}_{t}^{+}\end{matrix} \\ Δ f = f ( k 1 , t ) - f ( k 2 , t ) \qquad ( 1 )$$

where f(k) denotes a luminance value of a pixel ‘k’, k1 and k2 denote the positions of pixels, t represents a differential pattern, and Thₜ− and Thₜ+ denote threshold values. The difference detection value ht(x) has a value ‘+1’ indicating an edge component area and ‘−1’ indicating a halftone dot area.

Referring back to the flowchart of FIG. 4, after computation of the difference detection value ht(x) with regard to each differential pattern ‘t’ at step S221, the CPU 30 controls the attribute identification module 33 to compute a comprehensive difference detection value H(x), with a view to comprehensively identifying the attribute of the target pixel (step S222). The comprehensive difference detection value H(x) is expressed by Equation (2) given below:

$$H ( x ) = sign [ {\sum }_{t = 1}^{T} {α}_{t} {h}_{t} ( x ) ] \qquad ( 2 )$$

where αₜ denotes a weighting factor of the differential pattern ‘t’, and T represents the number of differential patterns. The weighting factor α is experimentally or empirically determined to minimize a detection error based on the difference detection value ht(x). The function ‘sign’ specifies a value according to the positive or negative sign of the computed summation, and gives a value ‘+1’ for the positive computed summation, a value ‘0’ for the zero computed summation, and a value ‘−1’ for the negative computed summation.

After computation of the comprehensive difference detection value H(x), the CPU 30 controls the attribute identification module 33 to determine whether the computed comprehensive difference detection value H(x) is not lower than 0 (step S223). When the comprehensive difference detection value H(x) is not lower than 0 (step S223: yes), it means that the difference detection value ht(x) is biased to the value ‘+1’. The target pixel is accordingly identified as a pixel in the edge component area (step S224). When the comprehensive difference detection value H(x) is lower than 0 (step S223: no), on the other hand, it means that the difference detection value ht(x) is biased to the value ‘−1’. The target pixel is accordingly identified as a pixel in the halftone dot area (step S225). On completion of such identification, the CPU 30 terminates the attribute identification process and returns the processing flow to the area classification process of FIG. 3.

In this embodiment, the eight differential patterns are set and stored in the differential pattern table 52. The number of differential patterns is, however, not restricted to 8, but may be any adequate number, for example, only one or 30. The number of differential patterns is adequately determined according to the required accuracy of identification and the allowed computation load. A specific differential pattern table 52 and specific weighting factors α may be provided for computation of the comprehensive difference detection value H(x) with regard to pixels constituting the edge of an image.

The specific range for selection of two arbitrary pixels is the area of 5 pixels by 5 pixels around the target pixel in the embodiment. The specific range is, however, not restricted to this 5□5 pixel area. Setting a wider pixel area to the specific range increases the degree of freedom in selection of differential patterns. The increased number of differential patterns, however, leads to the increased computation load. The pixel area of the specific range is thus determined adequately according to the required accuracy of identification and the allowed computation load. The pixel area of 5 pixels□5 pixels is preferable for the good balance of the accuracy of identification and the computation load. The specific range is not restricted to a square area (n pixels □ n pixel) but may be any other suitable area, for example, a rectangular area (m pixels □ n pixel), a cross area, a concavo-convex area.

The procedure of the embodiment uses the difference value between the luminance values of two selected pixels for identification of the attribute of each target pixel, since a variation in luminance value is readily detectable. The tone value used for attribute identification is not restricted to the luminance value but may be any other tone value representing the color of each pixel. For example, when the input image data is expressed in the YCbCr system, the Y component as the luminance value of each pixel may be used directly for attribute identification. Otherwise the Cb component or the Cr component may be used for the same purpose. The R component of each pixel may also be used for the same purpose. The difference value may be calculated from tone values of different color components, for example, a tone value of the R component in a pixel at a predetermined position and a tone value of the G component in another pixel at another predetermined position.

The procedure of the embodiment uses the difference value Δf between the luminance values of two pixels selected in the specific pixel range of 5 pixels by 5 pixels for identification of the attribute of each target pixel. The number of selected pixels for calculation of the difference value is not restricted to two pixels. For example, a total difference value as a sum of difference values of respective combinations (qCs) of q pixels (where q is an integer of not less than 3) may be used for identification of the attribute of each target pixel.

The procedure of the embodiment compares the difference value Δf with the preset threshold values to compute the difference detection value ht(x). One modification may compare the absolute value of the difference value Δf with adequately specified threshold values for the same purpose.

The procedure of the embodiment converts the difference value Δf into the difference detection value ht(x) ‘+1’, ‘0’, or ‘−1’. The difference detection value ht(x) is, however, not restricted to these values but may be any set of values reflecting a variation in tone value in each differential pattern. For example, the difference detection value ht(x) may give one of five values ‘+2’, ‘+1’, ‘0’, ‘−2’, and ‘−2’ according to the magnitude of the difference value Δf or may be equal to the difference value Δf between tone values of multiple selected pixels.

The printer 10 of the embodiment calculates the difference value Δf between the tone values of multiple pixels selected among peripheral pixels in the specific pixel range around each target pixel, computes the difference detection value ht(x) from the calculated difference value Δf, and identifies the attribute of the target pixel based on the computed difference detection value ht(x). The attribute of each pixel is thus identifiable as a pixel in the edge component area or a pixel in the halftone dot area by simple operations including calculation of the simple difference. The attribute identification requires only these simple operations and is thus inexpensively executable by the software configuration. The combination of such simple operations is implementable as a parallel operation suitable for SIMD (single instruction multiple data) and enables the high-speed processing.

The printer 10 of the embodiment computes the comprehensive difference detection value H(x) as combination of the multiple difference detection values ht(x) corresponding to the multiple differential patterns and uses the computed comprehensive difference detection value H(x) to comprehensively identify the attribute of each pixel. The experimentally or empirically determined weighting factor is used for the comprehensive attribute identification. This arrangement desirably improves the accuracy of identification.

B. Other Aspects

Some modifications of the embodiment are explained below.

B-1. Modification 1

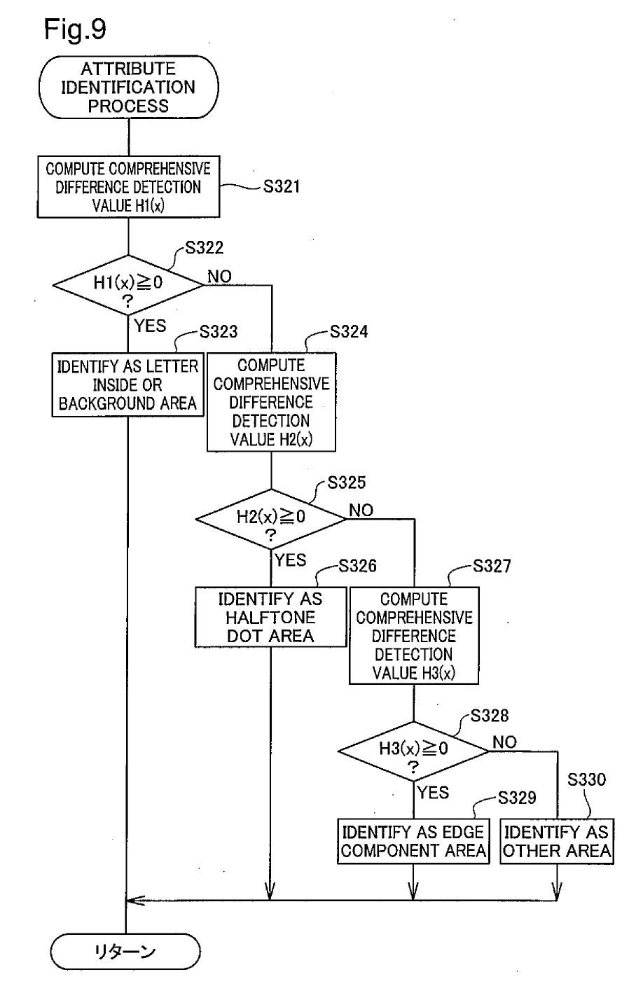

The procedure of the embodiment classifies pixels included in an image into the two attributes. Pixels may alternatively be classified into three or more attributes. For example, pixels may be classified into three attributes ‘letter interior or background area’, ‘halftone dot area’, and ‘edge component area’ according to a modified flow of attribute identification shown in the flowchart of FIG. 9. This modified attribute identification process of FIG. 9 first identifies whether each target pixel is a pixel in the ‘letter inside or background area’ or a pixel out of the ‘letter inside or background area’ (steps S321 to S323) in the similar manner as the attribute identification process of FIG. 8. Upon identification of the pixel out of the ‘letter inside or background area’ (step S322: no), the modified flow subsequently identifies whether the target pixel is a pixel in the ‘halftone dot area’ or a pixel out of the ‘halftone dot area’ (steps S324 to S326). Upon identification of the pixel output of the ‘halftone dot area’ (step S325: no), the modified flow identifies whether the target pixel is a pixel in the ‘edge component area’ or a pixel out of the ‘edge component area’ (steps S327 to S330). Three comprehensive difference detection values H1(x), H2(x), and H3(x) are computed with suitable threshold values and weighting factors a at steps S321, S324, and S327.

B-2. Modification 2

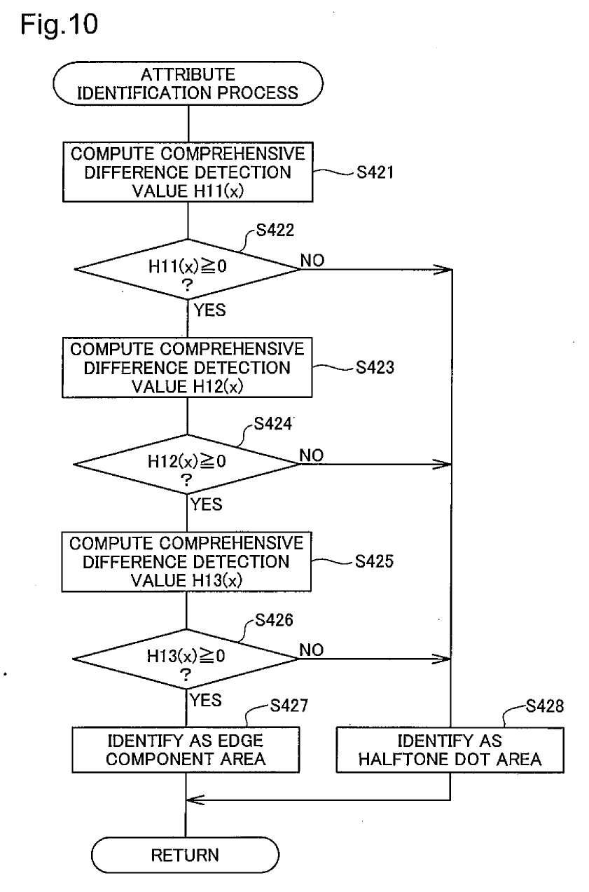

The procedure of the embodiment computes only one comprehensive difference detection value H(x) with regard to each target pixel for one-step attribute identification. Multi-step attribute identification may be performed instead. For example, three-step attribute identification may be performed with three comprehensive difference detection values H11(x), H12(x), and H13(x) according to a modified flow of FIG. 10. The number of differential patterns may be increased in the order of H11(x), H12(x), and H13(x). The comprehensive difference detection value used in the later stage is computed by using the increased number of differential patterns in combination of threshold values, thus enabling attribute identification of the higher accuracy. Such arrangement enables the higher-speed attribute identification by the operations according to the less number of differential patterns for the easily identifiable pixels, while enabling the more accurate but time-consuming attribute identification with an increase in difficulty of the identification. This desirably balances the accuracy of identification with the processing speed.

B-3. Modification 3

The procedure of the embodiment uses the same comprehensive difference detection value H(x) for attribute identification of each pixel, irrespective of the characteristic of the object image. The number and the variety of differential patterns may alternatively be changed over according to the characteristic of the object image. The characteristic of the image represents an image quality-related characteristic, for example, resolution of an image, color information (monochromatic/gray scale/color), or an image scan mode (letter-character mode/photographic mode). The accuracy of identification is generally varied according to the characteristic of the image. For example, the higher resolution enables attribute identification of the equivalent accuracy with the less number of differential patterns.

For example, multiple differential pattern tables 52 corresponding to multiple different resolutions of input images are stored in the ROM 50. Prior to step S221 in the attribute identification process of FIG. 4, the CPU 30 controls an image quality acquisition module 36 to specify the resolution of an input image read by the scanner 91, and subsequently controls a differential pattern changeover module 37 to change over the differential pattern table 52 adopted at step S221 corresponding to the specified resolution. This modified arrangement uses the differential pattern table 52 suitable for the characteristic of the object image to enable the more accurate attribute identification or the higher-speed attribute identification.

B-4. Modification 4

The procedure of the embodiment identifies the attribute of each pixel according to the attribute identification process at step S220 in the area classification process of FIG. 3, stores the results of the attribute identification, and performs the area correction process based on the stored results of the attribute identification at step S130 in the image copy routine of FIG. 2. A required series of image processing may be performed directly according to the computed difference detection values ht(x) or the computed comprehensive difference detection value H(x) as the parameter.

The embodiment and its modifications discussed above are to be considered in all aspects as illustrative and not restrictive. There may be many other modifications, changes, and alterations without departing from the scope or spirit of the main characteristics of the present invention. For example, the image processing device of the invention is not restrictively mounted on the complex machine described in the embodiment but is also applicable to any of various digital equipment, for example, a single-function printer, a digital copier, or an image scanner. The technique of the present invention is not restricted to the configuration of the image processing device but may be actualized by a pixel attribute identification method of identifying an attribute of each pixel included in an image as a type of an image area and a computer program corresponding to the pixel attribute identification method.

What is claimed is:

1. An image processing device constructed to identify an attribute of each pixel included in an image as a type of an image area, the image processing device comprising:
a data input module configured to read tone value data representing tone values of respective pixels constituting the image;
a difference detection value computation module configured to select multiple pixels among a predetermined pixel included in the image and peripheral pixels in a specific range around the predetermined pixel and compute a difference detection value from a difference value between tone values of the selected multiple pixels according to a combination pattern of the selected multiple pixels; and
an attribute identification module configured to identify an attribute of the predetermined pixel as the type of an image area, based on the computed difference detection value.

2. The image processing device in accordance with claim 1, wherein the difference detection value computation module provides multiple combination patterns, calculates multiple difference values corresponding to the multiple combination patterns, and computes multiple difference detection values from the calculated multiple difference values.

3. The image processing device in accordance with claim 2, wherein the attribute identification module gives weights to the multiple combination patterns and uses the weighted multiple combination patterns for identification of the attribute.

4. The image processing device in accordance with claim 2, wherein when the computed difference detection value represents a certain result, the difference detection value computation module increases a variety of combination patterns to recompute the difference detection value, and
the attribute identification module performs identification of the attribute based on the recomputed difference detection value.

5. The image processing device in accordance with claim 3, wherein when the computed difference detection value represents a certain result, the difference detection value computation module increases a variety of combination patterns to recompute the difference detection value, and
the attribute identification module performs identification of the attribute based on the recomputed difference detection value.

6. The image processing device in accordance with claim 2, the image processing device further having:
an information acquisition module configured to obtain image quality-related information on a quality of the image; and
a pattern changeover module configured to change over at least a number of combination patters or a variety of combination patterns according to the obtained image quality-related information.

7. An image processing device constructed to make an image subjected to a series of image processing, the image processing device comprising:
a data input module configured to read tone value data representing tone values of respective pixels constituting the image;
a difference detection value computation module configured to select multiple pixels among a predetermined pixel included in the image and peripheral pixels in a specific range around the predetermined pixel and compute a difference detection value from a difference value between tone values of the selected multiple pixels; and
an image processing module configured to make at least part of the image subjected to an image processing operation according to the computed difference detection value.

8. A pixel attribute identification method of identifying an attribute of a pixel included in an image as a type of an image area, the pixel attribute identification method comprising:
reading tone value data representing tone values of respective pixels constituting the image;
selecting multiple pixels among a predetermined pixel included in the image and peripheral pixels in a specific range around the predetermined pixel and computing a difference detection value from a difference value between tone values of the selected multiple pixels according to a combination pattern of the selected multiple pixels; and
identifying an attribute of the predetermined pixel as the type of an image area, based on the computed difference detection value.
